(19) United States
(12) Patent Application Publication
(10) Pub. No.: US 2005/0231764 A1
(43) Pub. Date: Oct. 20, 2005

(54) Image forming apparatus for managing temporarily stored data

(76) Inventors: Norio Michiie, Tokyo (JP); Hiromitsu Shimizu, Yokohama-shi (JP); Yuriko Obata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/997,870

(22) Filed: Nov. 29, 2004

(30) Foreign Application Priority Data
Nov. 28, 2003 (JP) JP2003-400411

(51) Int. Cl. G06F 15/00

(52) U.S. Cl. 358/1.16

(57) ABSTRACT

An image forming apparatus includes an image input device configured to input image data, a storage device configured to temporarily store the image data inputted by the image input device, an image output device configured to output the image data read from the storage device, and a deletion device configured to delete the image data stored in the storage device.

### BACKGROUND OF THE INVENTION

1. Field of the Invention

The present invention relates generally to an image forming apparatus, and, more particularly to an image forming apparatus capable of preventing leakage to enhance security of received image data stored in an image data storage device.

2. Description of the Related Art

In an image forming apparatus including an original document reading device such as a scanner, an image outputting device such as a printer, and an image data storage device for storing image data, the input and output of image data, and, the associated processing relative to input image data are performed in response to user requests. Also, in a so-called multi-function image forming apparatus capable of connecting with a facsimile apparatus, a network, etc., input and output of image data, and, image data processing of inputted image data are also performed. Various methods are used for increasing the speed of input and output of image data and associated image data processing.

One technology for speeding up the input and output of image data is a chain DMA method and a DMA controller such as described in Japanese Patent laid-open publication No. 6-103225. The chain DMA method enables a chain to be formed in a flexible way without increasing the descriptor area in an external memory. The DMA method also does not increase the number of the operations of accepting a descriptor by applying a memory control technology using a DMA method of input and output of a semiconductor memory.

Japanese Patent laid-open publication No. 5-304575 describes a digital copier capable of using another copier, which is not in use, as an output device. The digital copier includes a transceiver and a memory control device and is configured to cause another copier to output a duplicate image of an image being outputted synchronously with respect to a copying operation of the digital copier.

It is also well known to include a buffer memory, in addition to the main memory, for each image input device and image output device to execute image data processing of input image data and for outputting processed image data at a high speed. The buffer memory may be used for temporarily storing image data for image data processing.

Japanese Patent laid-open publication No. 6-30207 describes a facsimile apparatus in which a limited capacity of an image memory is effectively used by deleting unnecessary image data stored in the image memory in units of a page. A control function enables deleting unnecessary image data stored in the image memory selectively in units of a page.

Japanese Patent laid-open publication No. 9-223061 describes an information processing apparatus in which when a confidential mode is set, image data obtained by reading an original document and stored on a hard disk is deleted after outputting the image data, and when the confidential mode is not set, the image data stored to the hard disk is maintained after outputting thereof.

Furthermore, as an international standard with respect to information security, ISO/IEC 15408 has been recently established. This standard is now generally required so that when data is stored in a storage device, a function of preventing leakage of the data stored in the storage device is provided. For example, when a storage device such as a hard disk is connected with an image forming apparatus, to prevent leakage of image data stored to the hard disk, such functions as encrypting image data, limiting access to image files by setting permission authorization, setting a password, etc. are provided. A known product deletes, when deleting image data, not only the allocation data of a file but also the image data area. Another known product employs a mechanism allowing easy attachment and detachment of a storage device by the user.

In the above-described background technology of using a buffer memory to speed up processing of input image data and outputting the image data after performing image data processing of the image data, image data temporarily stored in the buffer memory for performing image data processing of the image data is kept stored in the buffer memory even after the image data has been read out from the buffer memory. In this case, even if the function to read out image data stored in the buffer memory is not provided, a possibility exists that the image data stored in the buffer memory is read by a third party.

When the capacity of the buffer memory is relatively small, even after image data stored in the buffer memory is read, identification of the contents of the image data may be difficult. However, when the capacity of the buffer memory is large enough to store image data for about one page, it may be possible to identify the contents of image data stored in the buffer memory by reading the image data. When image data is confidential data, if the image data stored in the buffer memory may be read by a third party, the confidential image data may leak out.

### SUMMARY OF THE INVENTION

According to one exemplary embodiment of the present invention, an image forming apparatus may include an image input device configured to input image data, a storage device configured to temporarily store the image data inputted by the image input device, an image output device configured to output the image data read from the storage device, and a deletion device configured to delete the image data stored in the storage device. In another exemplary embodiment consistent with the present invention, the image forming apparatus may further include a setting device configured to set whether or not to delete the image data stored in the storage device.

In yet another exemplary embodiment consistent with the present invention, the image forming apparatus may further include a setting device configured to set a unit amount of image data to be deleted at one time when the image data stored in the storage device is deleted by the image deletion device.

In still another exemplary embodiment consistent with the present invention, the image forming apparatus may include an image data processing device configured to perform image data processing of the image data so as to provide processed image data and to output the processed image data after performing the image data processing of the image data.

Further, in the image forming apparatus including the image data processing device, the image deletion device may delete the image data stored in the storage device, inputted by the image input device to be temporality stored in the storage device and read out from the storage device, when the image data processing to the image data, inputted by the image input device to be temporality stored in the storage device and read out from the storage device, by the image data processing device has been completed or when outputting of the image data, after performing the image data processing to the image data, from the image data processing device to the image output device has been completed.

Furthermore, in the image forming apparatus including the image data processing device, the image output device may be configured to output the image data, outputted from the image processing device after performing the image data processing to the image data, to a storage device storing the image data, a display device displaying the image data or a print device printing the image data.

It is to be understood that both the foregoing general description of the invention and the following detailed description are exemplary, and are not restrictive of the invention.

### BRIEF DESCRIPTION OF THE SEVERAL VIEWS OF THE DRAWINGS

A more complete appreciation of the present invention and many of the attended advantages thereof will be readily obtained as the present invention becomes better understood by reference to the following detailed description when considered in connection with the accompanying drawings, in which like reference characters refer to like parts throughout, wherein:

FIG. 1 is a schematic diagram of an illustrative digital copier consistent with the present invention;

FIG. 2 is a top view of an illustrative embodiment of a surface of an original document table of a digital copier of FIG. 1;

FIG. 3 shows an illustrative timing chart of an image synchronization signal outputted from an image processing unit of a digital copier consistent with the present invention;

FIG. 4 is a block diagram of an illustrative embodiment of a storage unit of a digital copier consistent with the present invention;

FIG. 5 is a block diagram of an illustrative embodiment of a memory controller of a digital copier consistent with the present invention;

FIG. 6 is a block diagram of an illustrative embodiment of a multi-function apparatus consistent with the present invention;

FIG. 7 is a schematic diagram of an illustrative multi-function apparatus consistent with the present invention;

FIG. 8 is a schematic diagram of an illustrative ASIC used in a controller of a multi-function apparatus consistent with the present invention;

FIG. 9A is a high level block diagram of an illustrative embodiment of a portion of an engine unit of a multi-function apparatus consistent with the present invention;

FIG. 9B is a high level block diagram of an illustrative embodiment of another portion of the engine unit of FIG. 9A consistent with the present invention.

FIG. 10 is a flowchart of an illustrative procedure for writing inputted image data to an image output device of a digital copier or a multi-function apparatus consistent with the present invention; and

FIG. 11 is a flowchart of an illustrative procedure for executing processes when writing input image data to an image output device of a digital copier or a multi-function apparatus consistent with the present invention.

### DETAILED DESCRIPTION OF THE INVENTION

Referring now to the drawings, wherein like reference numerals designate identical or corresponding parts throughout the several views, embodiments of the present invention are described.

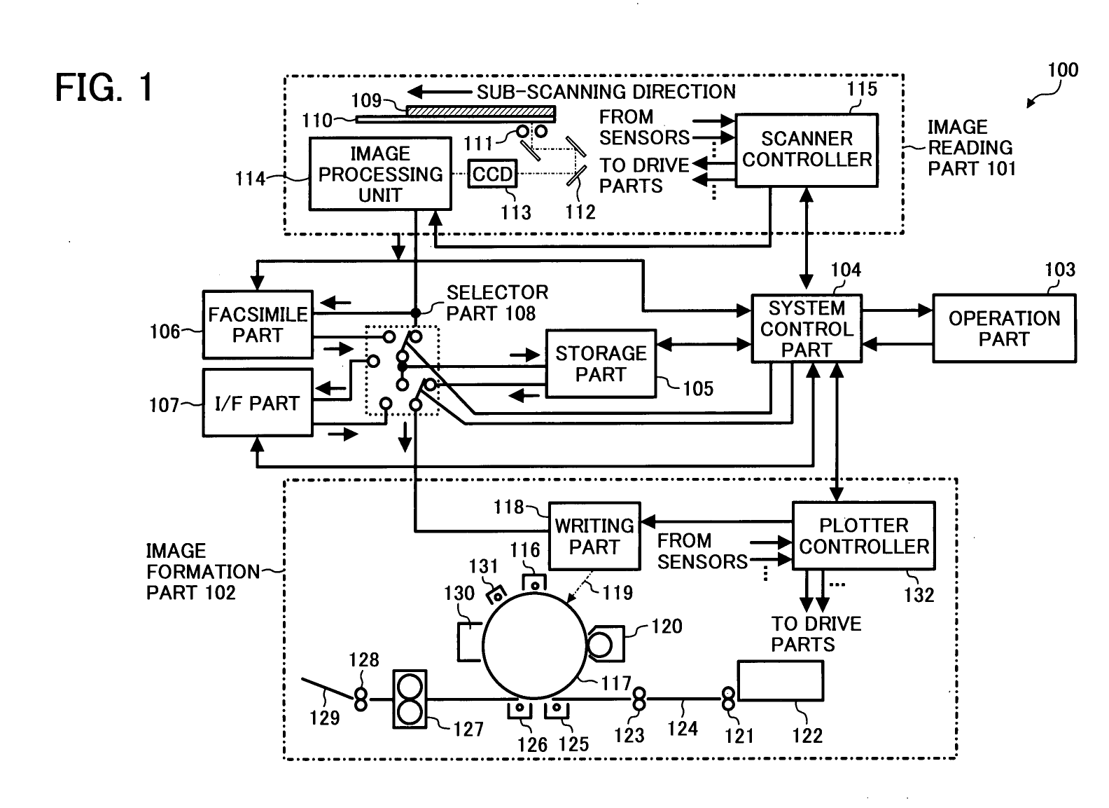

FIG. 1 is a schematic diagram of an illustrative digital copier consistent with the present invention. A digital copier 100 may include an image reading unit 101, an image formation unit 102, an operation unit 103, a system controller 104, a storage unit 105, a facsimile unit 106, an I/F (interface) unit 107, and a selector unit 108. Of course, those skilled in the art will recognize that further accessories and/or interfaces may be employed as desired and that the invention is not limited to any specific combination or arrangement as illustrated.

The image reading unit 101 may optically scan an original document 109 placed on an original document table 110 with an exposure lamp 111 that may travel along the original document table 110. Reflected light from the original document 109 may be reflected by reflective mirrors 112 and may be received by a charge coupled device (CCD) 113. The reflected light received by the CCD 113 may be photo-electrically converted to electrical signals, for example, according to optical strengths. An image processing unit 114 may convert analog electrical signals to, for example, 8-bit digital image signals by performing analog-to-digital conversion, and after performing optional shading correction, may further perform image processing such as enlargement and reduction and dither processing of the digital image signals, and then may send the digital image signals to the image formation unit 102 together with, for example, an image synchronization signal.

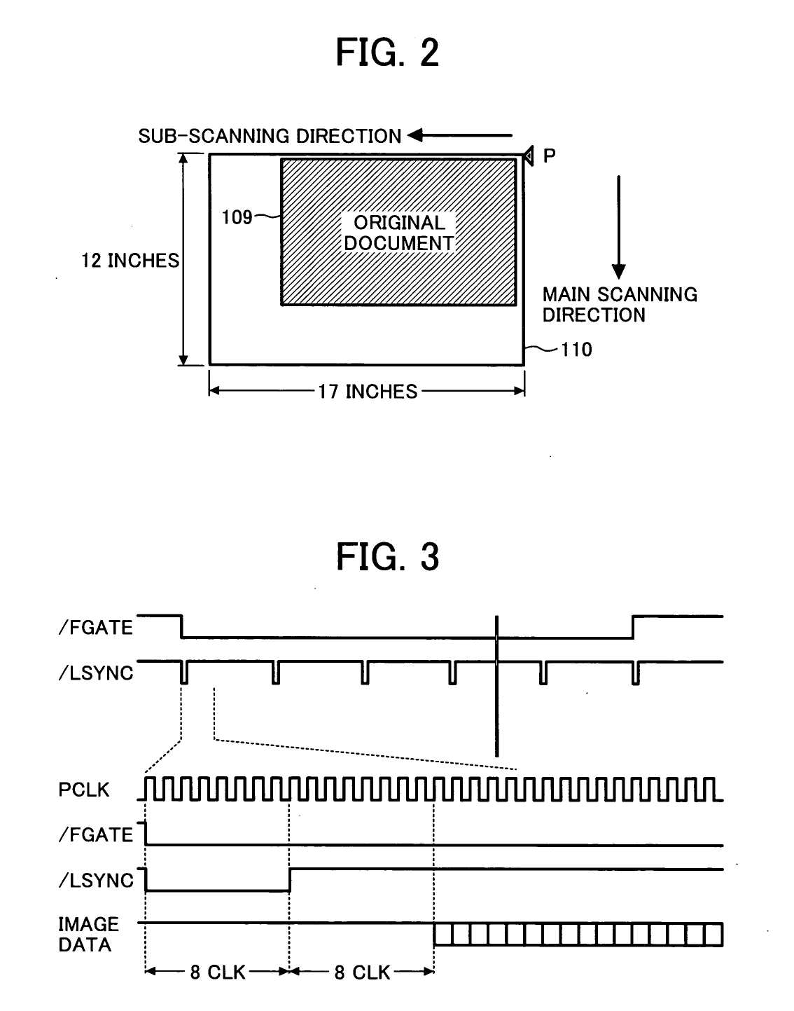

FIG. 2 is a top view of an illustrative embodiment of a surface of an original document table 110. The original document table 110 may be, for example, 17 inches long in the sub-scanning direction and 12 inches long in the main scanning direction. As illustrated in FIG. 2, the original document 109 may be placed on the original document table 110 and may be aligned with the edges of the original document table 110.

A scanner controller 115 of the image reading unit 101 of FIG. 1 may control detection by various sensors and driving of a drive motor for executing processes described above, and may set various parameters for the image processing unit 114.

The image formation unit 102 may expose a surface of a rotating photoconductor 117 to laser light 119 modulated according to image data from a writing unit 118 serving as an image output device. The surface of the rotating photoconductor 117 may be uniformly charged by a charging device 116. An electrostatic latent image may be formed on the surface of the photoconductor 117 by the laser light 119. Then, the electrostatic latent image may be visualized with toner by a development device 120, and thereby a toner image may be formed on the photoconductor 117. A transfer sheet 124 fed from a sheet feed tray 122 by a feed roller 121 and held at a registration roller 123 may be conveyed in synchronism with the photoconductor 117, and the toner image on the photoconductor 117 may be electrostatically transferred onto the transfer sheet 124 by a transfer charger 125. The transfer sheet 124 may be separated from the photoconductor 117 by a separation charger 126.

Thereafter, the toner image on the transfer sheet 124 may be heated and thereby fixed to the transfer sheet 124, and the transfer sheet 124 may be discharged onto a discharge tray 129 by a discharge roller 128. After transferring the toner image on the photoconductor 117 onto the transfer sheet 124, a cleaning device 130 may be pressed against the photoconductor 117, and thereby residual toner on the photoconductor 117 may be removed. Thereafter, the photoconductor 117 may be discharged with a discharger 131. A plotter controller 132 may control detection by various sensors and driving of a drive motor to execute the processes described above.

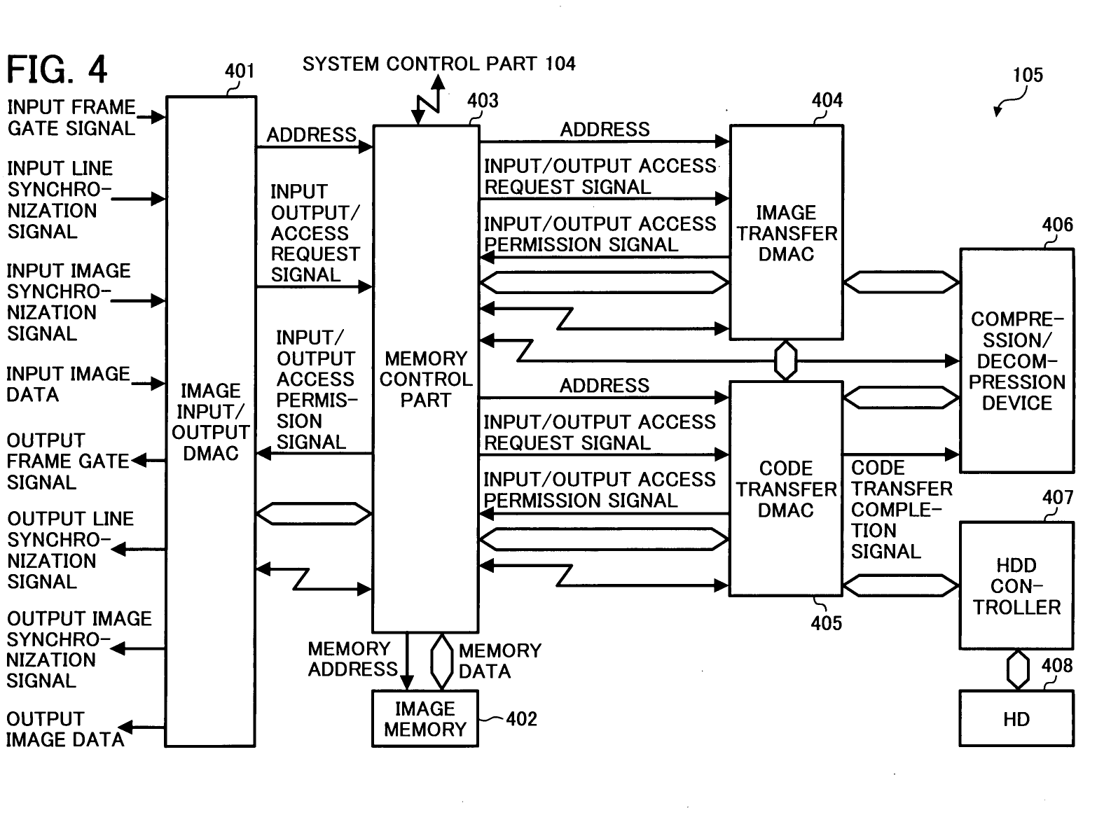

FIG. 3 is an illustrative timing chart of an image synchronization signal outputted from an image processing unit 114. In the timing chart, the horizontal axis indicates time.

A frame gate signal/FGATE may be a signal indicating an effective image area relative to an image area in the sub-scanning direction. Image data may be effective while the frame gate signal/FGATE is at the low level. The frame gate signal/FGATE may be asserted or negated at a rising or falling edge of a line synchronization signal/LSYNC. The line synchronization signal/LSYNC may be asserted for a predetermined number of clocks starting at a rising edge or falling edge of a pixel synchronization signal PCLK. Image data in the main scanning direction may become effective after the line synchronization signal/LSYNC is asserted and then following a predetermined number of clocks.

Image data of the original document 109 on the original document plate 110 of FIG. 2 maybe transmitted during one cycle of the pixel synchronization signal PCLK. The resolution of the image data may be, for example, 400 DPI. The image data may be output in a raster format starting with data at the start point indicated by the arrow mark P of FIG. 2. The effective area of image data in the sub-scanning direction may be determined by the size of the transfer sheet 124 of FIG. 1.

Referring back to FIG. 1, the system controller 104 may detect an input state of the operation unit 103 and transmit instructions for setting various parameters and executing processes to, for example, the image reading unit 101, the storage unit 105, the image formation unit 102, the facsimile unit 106, and the I/F unit 107. Further, the system controller 104 may display a state of the entire system, for example, through the operation unit 103. The instructions to the system controller 104 may be inputted by an operator, for example, through manipulation of keys provided in the operation unit 103 or as part of a control stream from a remote location.

The facsimile unit 106 may compress received image data, according to an instruction from the system controller 104, for example, based on the data transfer specification of G4 standard, and then may transmit the data through a telecommunication line. The facsimile unit 106 may decompress image data received through the telecommunication line and may generate binary image data. Then, the facsimile unit 106 may transmit the binary image data to be visualized to the writing unit 118 of the image formation unit 102. The I/F unit 107 may transmit data stored in the storage unit 105, for example, to an external storage device, and to receive and store data into the storage unit 105, for example, according to instructions from the system controller 104.

The selector unit 108 may change the state thereof according to an instruction from the system controller 104 to select data for forming an image among data from the image reading unit 101, data from the storage unit 105, data from the facsimile unit 106, and data from the I/F unit 107. The storage unit 105 may store image data of the original document 109 inputted from the image processing unit 114 in copying applications such as repeated copying and rotating copying. Further, the storage unit 105 may be used as a buffer memory for temporarily storing binary image data transmitted from the facsimile unit 106. Furthermore, the storage unit 105 may be used to store information on input and outputting devices. The system controller 104 may control storing of image data into the storage unit 105.

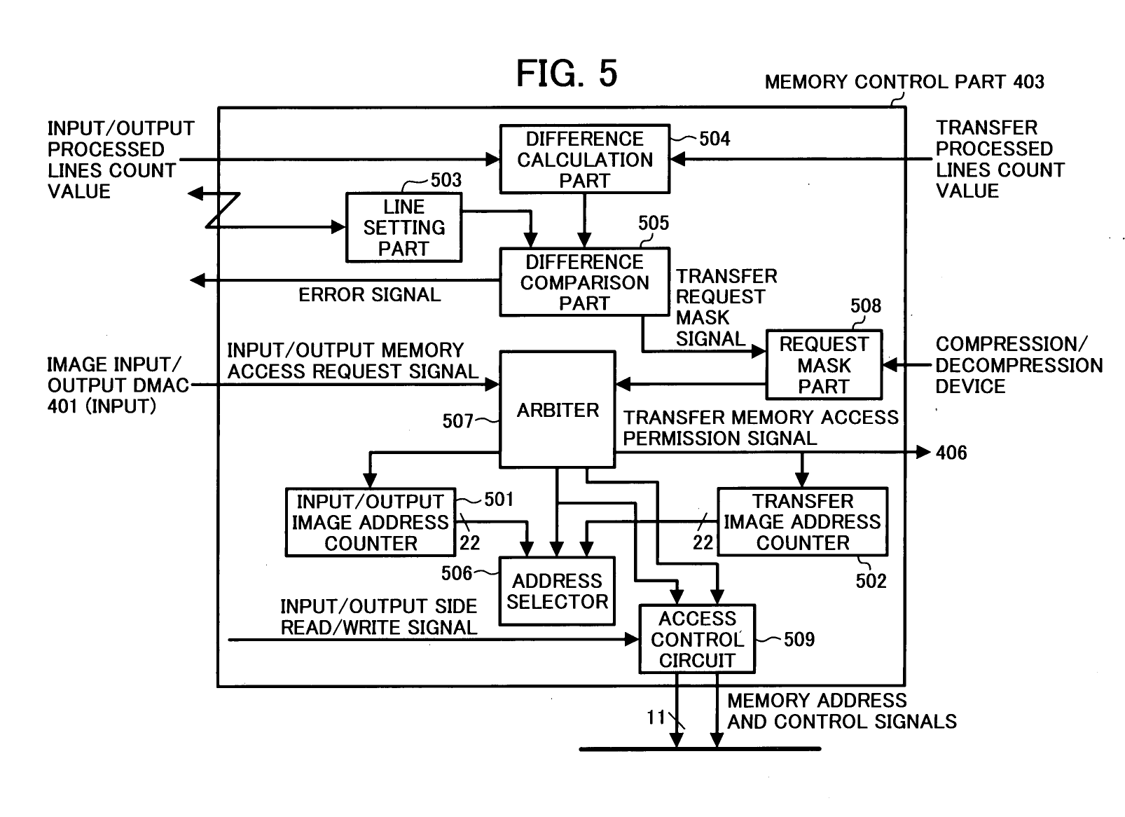

FIG. 4 is a block diagram of an illustrative embodiment of a storage unit 105. The storage unit 105 may include, for example, an image input/output DMAC 401, an image memory 402, a memory controller 403, an image transfer DMAC 404, a code transfer DMAC 405, a compression/decompression device 406, an HDD controller 407, and an HD 408.

The image input/output DMAC 401 may include a CPU and a logic circuit, and may receive commands from the memory controller 403 by communication and may set operations according to the commands. Further, the image input/output DMAC 401 may transmit status information informing the condition of the image input/output DMAC 401 to the memory controller 403. When a command for inputting an image has been received, the image input/output DMAC 401 may pack inputted image data in units of, for example, 8 pixels as memory data according to an input image synchronization signal, and may output the memory data, together with a memory access signal, to the memory controller 403. When a command for outputting an image has been received, the image input/output DMAC may output image data from the memory controller 403 in synchronism with an output image synchronization signal.

The image memory 402 may include a semiconductor storage element such as a DRAM. The image memory 402 may have the storage capacity of, for example, 16 MB in total, 4 MB for storing binary image data of an A3 size at 400 DPI resolution, 4 MB for storing image data in electronic sorting, 6 MB as the work area in data transferring, and 2 MB as the image data management area. Storing and reading of image data into and from the image memory 402 may be controlled by the memory controller 403.

The memory controller 403 may include a CPU and a logic circuit, and may receive commands from the system controller 104 by communication and may set operations according to the commands. Further, the memory controller 403 may transmit status information informing the condition of the storage unit 105 to the system controller 104. The operation commands from the system controller 104 may include, for example, commands for inputting an image, outputting an image, and compressing and decompressing image data. The commands for inputting and outputting images may be transmitted to the image input/output DMAC 401, and the commands for compressing and decompressing image data may be transmitted to, for example, the image transfer DMAC 404, the code transfer DMAC 405, and the compression/decompression device 406.

The image transfer DMAC 404 may include a CPU and a logic circuit, and may receive commands from the memory controller 403 by communication and may set operations according to the commands. Further, the image transfer DMAC 404 may transmit status information informing the condition thereof to the memory controller 403. When a command for compressing image data has been received, the image transfer DMAC 404 may output a memory access request signal to the memory controller 403, and when the memory access request signal is active, may receive image data and transfers the image data to the compression/decompression device 406. The image transfer DMAC 404 may include an address counter to count up according to memory access signals, and may output a memory address, for example, in 22 bits indicating a location for storing image data. Those skilled in the art will recognize that although separately described and depicted, the functionality of the CPU and the logic circuit may be combined in a simple structure or component.

The code transfer DMAC 405 may include a CPU and a logic circuit, and may receive commands from the memory controller 403 by communication and may set operations according to the commands. Further, the code transfer DMAC 404 may transmit status information informing the condition thereof to the memory controller 403. When a command for decompressing image data has been received, the code transfer DMAC 404 may output a memory access request signal to the memory controller 403, and when the memory access request signal is active, may receive image data and may transfer the image data to the compression/decompression device 406. The image transfer DMAC 404 may include an address counter to count up according to memory access request signals, and may output a memory address, for example, in 22 bits indicating a location for storing image data.

The compression/decompression device 406 may include a CPU and a logic circuit, and may be configured to receive commands from the memory controller 403 by communication and may set operations according to the commands. Further, the compression/decompression device 406 may transmit status information informing the condition thereof to the memory controller 403. The compression/decompression device 406 may process binary data, for example, using a MH (Modified Huffman) coding method.

The HDD controller 407 may include a CPU and a logic circuit, and may receive commands from the memory controller 403 by communication and may set operations according to the commands. Further, the HDD controller 407 may transmit status information informing the condition thereof to the memory controller 403. The HDD controller 407 may read the status of the HD 408 that may serve as a secondary storage device, and may perform transferring of data stored on the HD 408.

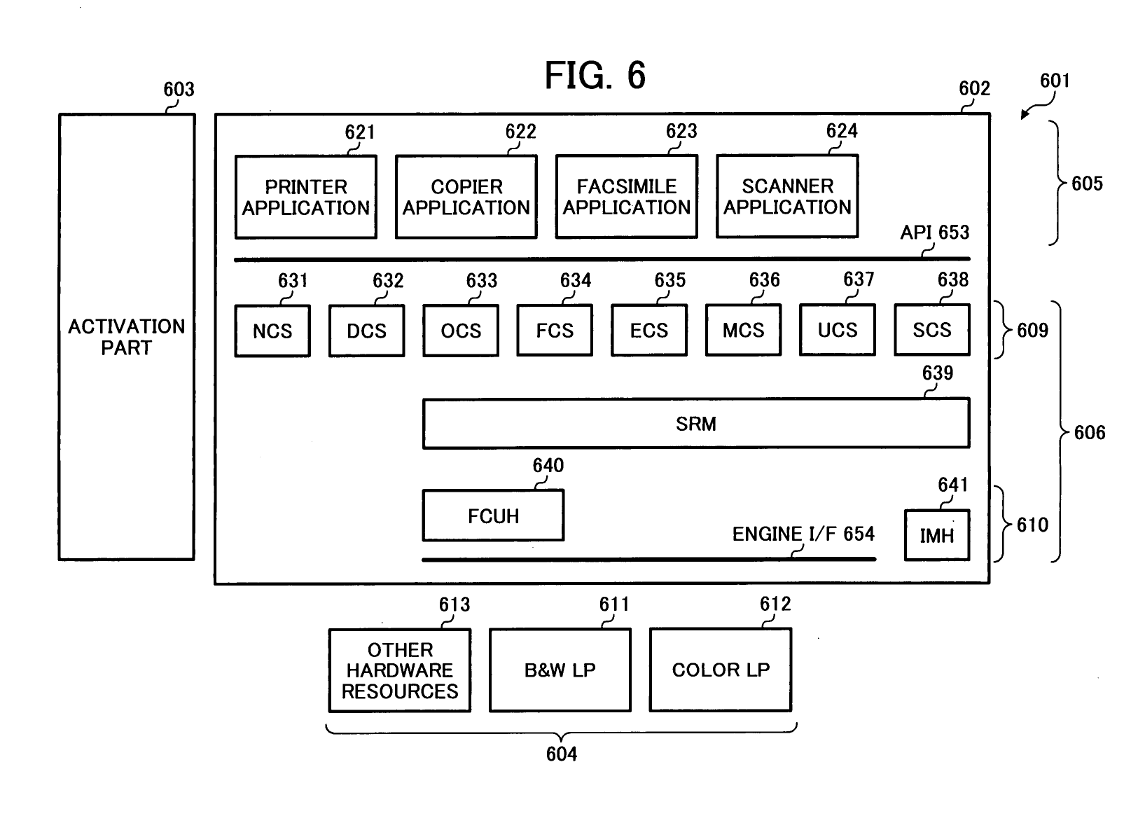

FIG. 5 is a block diagram of an illustrative embodiment of a memory controller 403. The memory controller 403 may include, for example, an input/output image address counter 501, a transfer image address counter 502, a line setting unit 503, a difference calculation unit 504, a difference comparison unit 505, an address selector 506, an arbiter 507, a request mask unit 508, and an access control circuit 509.

The input/output image address counter 501 may be an address counter counting up according to input/output memory access request signals, and may output a memory address, for example, in 22 bits indicating a location for storing input/output image data. When memory access is started, the input/output image address counter 501 may be initialized.

The transfer image address counter 502 may be an address counter counting up according to transfer memory access request signals, and may output a memory address in, for example, 22 bits indicating a location for storing transfer image data. When memory access is started, the transfer image address counter 502 may be initialized.

The line setting unit 503 may set a value, which may be outputted to the difference comparison unit 505 when using the image memory 402 as a buffer memory in inputting an image, from the system controller 104. An arbitrary value can be set. In one embodiment consistent with the present invention, the value may depend on the capabilities of the peripheral circuits of the memory controller 403. The peripheral circuits may include, for example, the image input/output DMAC 401, the image transfer DMAC 404, and the compression/decompression device 406. When the image transfer DMAC 404 can process 10 lines of image data at a time, for example, the value may be equal to or less than 11 lines.

The difference calculation unit 504 may subtract the number of input/output processed lines outputted from the image input/output DMAC 401 from the number of transfer processed lines outputted from the compression/decompression device 406 when inputting an image, and may output a result (the difference in number of lines) to the difference comparison unit 505.

The difference comparison unit 505 may compare the difference in number of lines outputted from the difference calculation unit 504 and the value outputted from the line setting unit 503 in inputting an image, and when the difference in number of lines equals to the value, may output an error signal. Further, when the difference in number of lines is zero, the difference comparison unit 505 may cause a transfer request mask signal as to the comparison result, which is outputted to the arbiter 507, to be active. The transfer request mask signal may not be caused to be active, for example, except when the difference in number of lines is zero and when inputting and outputting of images are not being performed.

The arbiter 507 may output a transfer memory access permission signal for gaining access to the compression/decompression device 406. The transfer memory access permission signal may be outputted on the condition that an address comparison signal is active and an input/output memory access request signal is not active.

The request mask unit 508 may mask a transfer memory access request signal for gaining access to the compression/decompression device 406 based on a comparison result from the difference comparison unit 505, for example, to stop a transfer process.

The access control circuit 509 may divide an input physical address into a raw address and a column address corresponding to the image memory 402 and may output the addresses as memory addresses, for example, in 11 bits. The access control circuit 509 may also output DRAM control signals (RAS, CAS, WE) according to an access start signal from the arbiter 507.

The memory controller 403 may be initialized according to an instruction of inputting an image from the system controller 104 and may be put into an image data waiting state, and image data may be inputted to the storage unit 105 by an operation at the image reading unit 101. Inputted image data may be stored in the image memory 402 that may serve as a buffer memory. The number of processed lines of inputted image data may be counted by the image input/output DMAC 401 and may be inputted to the memory controller 403. The compression/decompression device 406 may output a transfer memory access request signal upon receiving an image transfer command, however, the transfer memory access request signal may be masked by the request mask unit 508 of the memory controller 403, so that actual memory access is not performed.

Upon completion of inputting data for one line from the image input/output DMAC 401, masking of the transfer memory access request signal may be released, and reading of inputted image data stored in the image memory 402 may be performed and an operation of transferring the read image data to the compression/decompression device 406 may be started. The difference between the number of transfer processed lines outputted from the compression/decompression device 406 and the number of input/output processed lines outputted from the image input/output DMAC 401 may be calculated at the difference calculation unit 504 during the operation, and when the number of difference in lines is zero, the transfer memory access request signal may be masked so that overrunning of an address is prevented.

As described above, when inputting an image, the storage unit 105 of FIG. 4 may write image data into and read the image data from a predetermined image area of the image memory 402 that may serve as a buffer memory with the image transfer DMAC 404 according to instructions from the system controller 104. At this time, the number of processed lines of the image data may be counted at the image transfer DMAC 404.

Now, a multi-function apparatus as an image forming apparatus according to another embodiment consistent with the present invention is described.

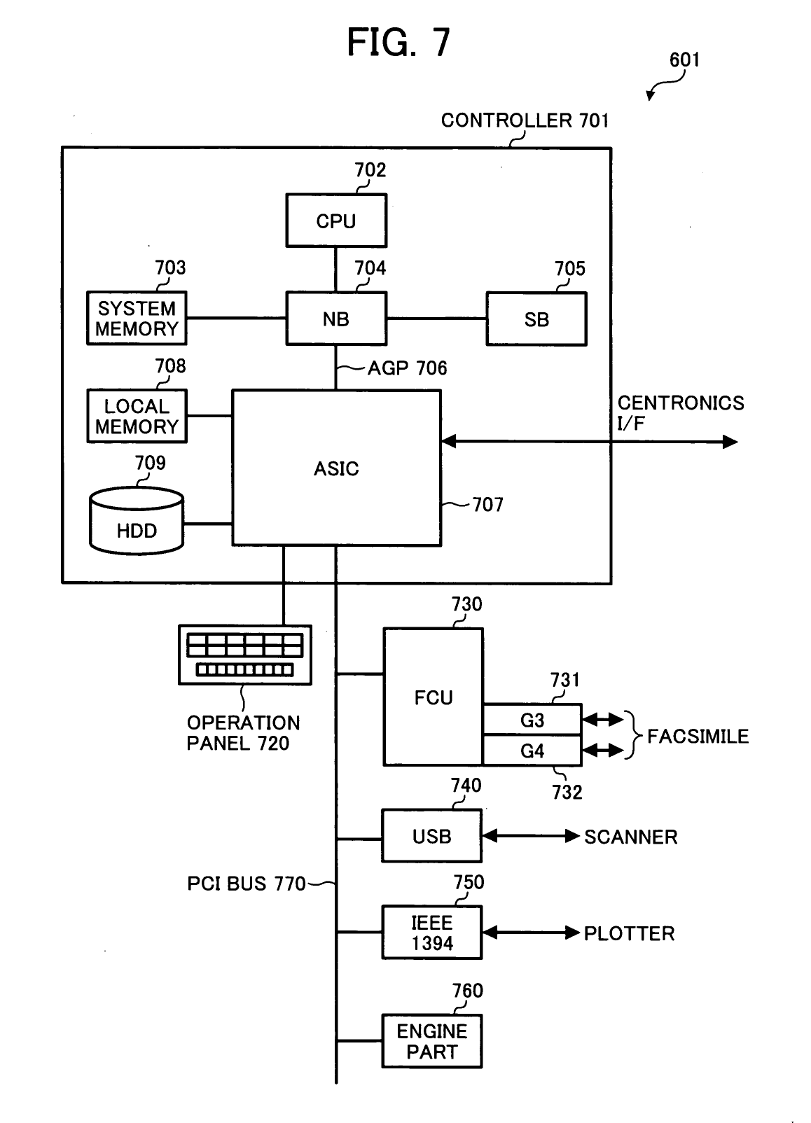

FIG. 6 shows a block diagram of an illustrative embodiment of a multi-function apparatus 601 consistent with the present invention. The multi-function apparatus 601 may be an image forming apparatus in which, for example, functions of a printer, a copier, a facsimile apparatus, and a scanner are accommodated in a single housing.

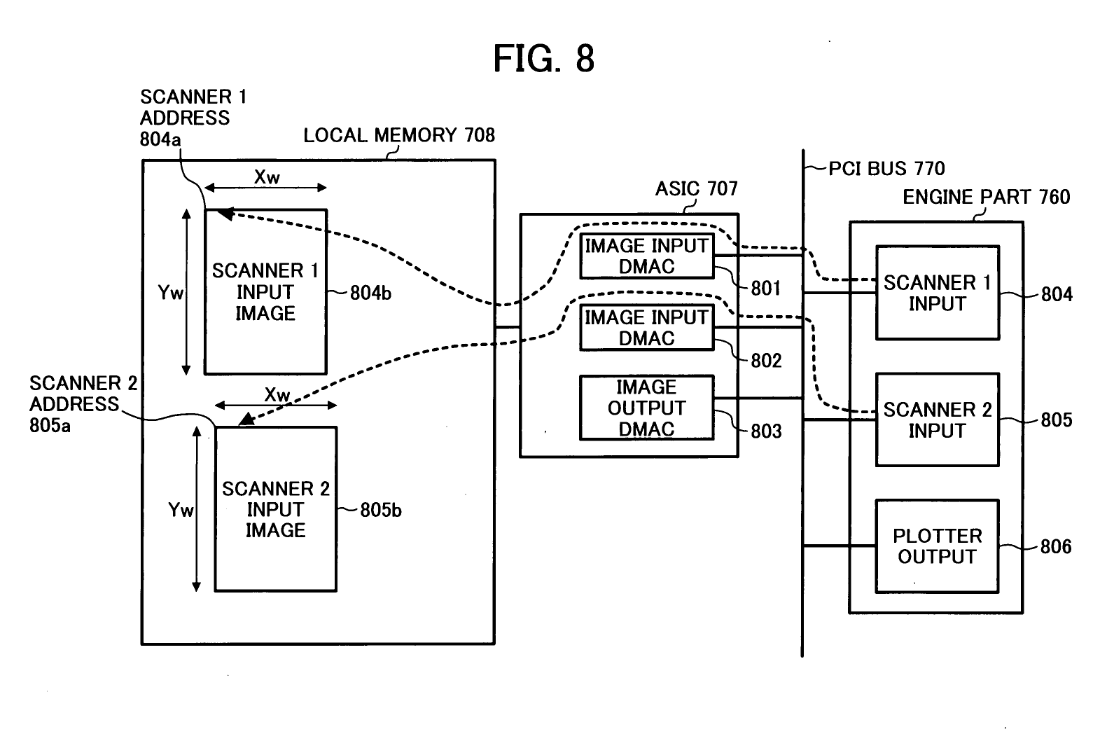

The multi-function apparatus 601 may include a software resource 602, an activation unit 603, and a hardware resource 604. The activation unit 601 may be activated first when the power of the multi-function apparatus 601 is turned on, and may activate an application layer 605 and a platform 606 of the software resource 602. For example, the activation unit 603 may read programs of the application layer 606 and the platform 606 from an external storage device (e.g., a hard disk device), and may transfer each program to an area in a system memory 703 (FIG. 7) to be activated.

The hardware resource 604 may include a black-and-white laser printer (B&W LP) 611, a color laser printer (color LP) 612, and other hardware resources 613 (e.g., a scanner, a facsimile apparatus, etc.)

The software resource 602 may include the application layer 605 and the platform 606, which may be activated on an operation system (OS) such as UNIX, LINUX, Microsoft Windows, or other proprietary platforms. The application layer 605 may include programs performing processes relating to functions of image formation such as printing, copying, facsimile transmitting/receiving, and scanning functions.

The application layer 605 may include, for example, a printer application 621 as an application program for the printing function, a copier application 622 as an application program for the copying function, a facsimile application 623 as an application program for the facsimile transmitting/receiving function, and a scanner application 624 as an application program for the scanning function.

The platform 606 may include, for example, a control service layer 609 that may generate a request for acquiring the hardware resource 604 by interpreting a processing request from the application layer 605, a system resource manager (SRM) 639 that may manage one or more elements of the hardware resource 604 and may arbitrate requests for acquiring the hardware resource 604 from the control service layer 609, and a handler layer 610 that may manage the hardware resource 604 in response to a request for acquiring the hardware resource 604 from the SRM 639.

The control service layer 609 may include, for example, one or more of the following service modules: a network control service (NCS) 631, a delivery control service (DCS) 632, an operation control service (OCS) 633, a facsimile control service (FCS) 634, an engine control service (ECS) 635, a memory control service (MCS) 636, a user information control service (UCS) 637, and a system control service (SCS) 638.

The platform 606 may receive a processing request from the application layer 605 via an API 653 by a predetermined function. The OS may execute each program of the application layer 605 and the platform 606 in parallel.

The process of the NCS 631 may provide a common service to applications requiring a network I/O. The process of the NCS 631 may distribute data received based on each protocol from the network side to a corresponding application, and may act as an intermediary when transmitting data from each application to the network side. For example, the process of the NCS 631 may control data communication with a network device connected via a network with HTTPD (Hypertext Transfer Protocol Daemon) based on HTTP (Hypertext Transfer Protocol).

The process of the DCS 632 may control delivery of a stored document. The process of the OCS 633 may control an operation panel 720 (FIG. 7) that may act as an information transmitting unit between an operator and a controller 701 (FIG. 7) of the multi-function apparatus 601.

The process of the FCS 634 may provide, for example, an API for performing, at the application layer 605, facsimile transmitting and receiving using a PSTN (Public Switched Telephone Network) or an ISDN (Integrated Switched Services Digital Network), registering and referencing of facsimile data managed at a local memory 708 (FIG. 7) as a back-up memory, reading of a document for facsimile transmission, and printing of received facsimile data, among others.

The process of the ECS 635 may control, for example, engines of the black-and-white laser printer (B&W LP) 611, the color laser printer (color LP) 612 and the other hardware resources 613. The process of the MCS 636 may control, for example, acquiring and releasing of an area of the system memory 703 of FIG. 7 and utilization of a HDD 709 of FIG. 7. The process of the UCS 637 may manage user information. The process of the SCS 638 may perform, for example, application management, operation unit control, system screen display control, LED display control, hardware resource management, interrupt application control, etc.

The process of the SRM 639 may perform system control and management of the hardware resource 604 in cooperation with the SCS 638. For example, the process of the SRM 639 may perform mediation in accordance with a request from an upper layer for acquiring the black-and-white-laser printer (B&W LP) 611, the color laser printer (color LP) 612, etc. of the hardware resource 604, and may control executing the contents of the request. Specifically, the process of the SRM 639 may determine whether or not the requested hardware resource 604 (the black-and-white-laser printer 611, the color laser printer 612 or the other hardware resource 613) can be used (i.e., is not being used by another request), and when the requested hardware resource 604 can be used and may inform to the upper layer. Further, the process of the SRM 639 may perform scheduling of using the hardware resource 604 in accordance with requests for acquiring the hardware resource 604 from the upper layer, and may directly execute the contents of the requests, e.g., an operation of conveying a sheet and forming an image by an engine unit 760 of FIG. 7, acquisition of an area in the system memory 703 of IG. 7, generation of a file, etc.

The handler layer 610 may include a facsimile control unit handler (FCSH) 640 that may manage a facsimile control unit 730 of FIG. 7, and an image memory handler (IMH) 641 that may allocate the system memory 703 to processes and may manage allocation of the system memory 703 to the processes. The SRM 639 and the FCUH 640 may request processing of the hardware resource 604 using an engine I/F 654 that may enable transmission of a processing request to the hardware resource 604 by a predetermined function. Thus, the multi-function apparatus 601 may perform processes commonly required by applications at the platform 606.

FIG. 7 is a schematic diagram of an illustrative multi-function apparatus 601 consistent with the present invention. The multi-function apparatus 601 may include, for example, a controller 701, an operation panel 720, the FCU 730 including a G3 device 731 and a G4 device 732, a USB device 740, an IEEE1394 device 750, and the engine unit 760.

The controller 701 may include a CPU 702, the system memory 703, a north bridge (NB) 704, a south bridge (SB) 705, an ASIC 707, the local memory 708, and the HDD 709. The operation panel 720 may be connected with the ASIC 707 of the controller 701. The FCU 730, the USB device 740, the IEEE1394 device 750, and the engine unit 760 may be connected to the ASIC 707 of the controller 701 by a PCI bus 770. The FCU 730 may be used for connection with facsimile apparatuses, and the IEEE1394 device 750 may be used for connection with a scanner, a plotter, etc.

The ASIC 707 may be connected with the local memory 708 and the HDD 709, and may also be connected with the CPU 702 via the NB 704. By connecting the CPU 702 and the ASIC 707 with each other via the NB 704, an unopened interface of the CPU 702 can be worked around.

In one embodiment consistent with the present invention, the ASIC 707 and the NB 704 may be connected with each other via an AGP (Accelerated Graphics Port) 706 capable of transferring data at a high speed. Thus, in order to perform one or more processes of the application layer 605 and the platform 606 illustrated in FIG. 6, the ASIC 707 and the NB 704 may be connected with each other via the AGP 706, and thereby decrease of the performance is avoided.

The CPU 702 may control the multi-function apparatus 601, and may activate and execute the NCS 631, the DCS 632, the OCS 633, the FCS 634, the ECS 635, the MCS 636, the UCS 637, the SCS 638, the SRM 639, the FCUH 640, and the IMH 641 on the OS as processes, respectively, and further, may activate and execute the printer application 621, the copier application 622, the facsimile application 623, and the scanner application 624 of the application layer 605.

The NB 704 may connect the CPU 702, the system memory 703, the SB 705, and the ASIC 707 with each other. The system memory 703 may be a memory used in plotting, etc. The SB 705 may connect the NB 704 with a ROM, a peripheral device (not shown) and/or the PCI bus 770. The local memory 708 may be used as a buffer memory in copying an image and/or compressing/decompressing image data.

The ASIC 707 may be an IC that may include hardware elements for image processing applications. The HDD 709 may be a storage device for storing image data, document data, programs, font data, form data, etc. The operation panel 720 may accept input operations by the operator, and may display information to the operator.

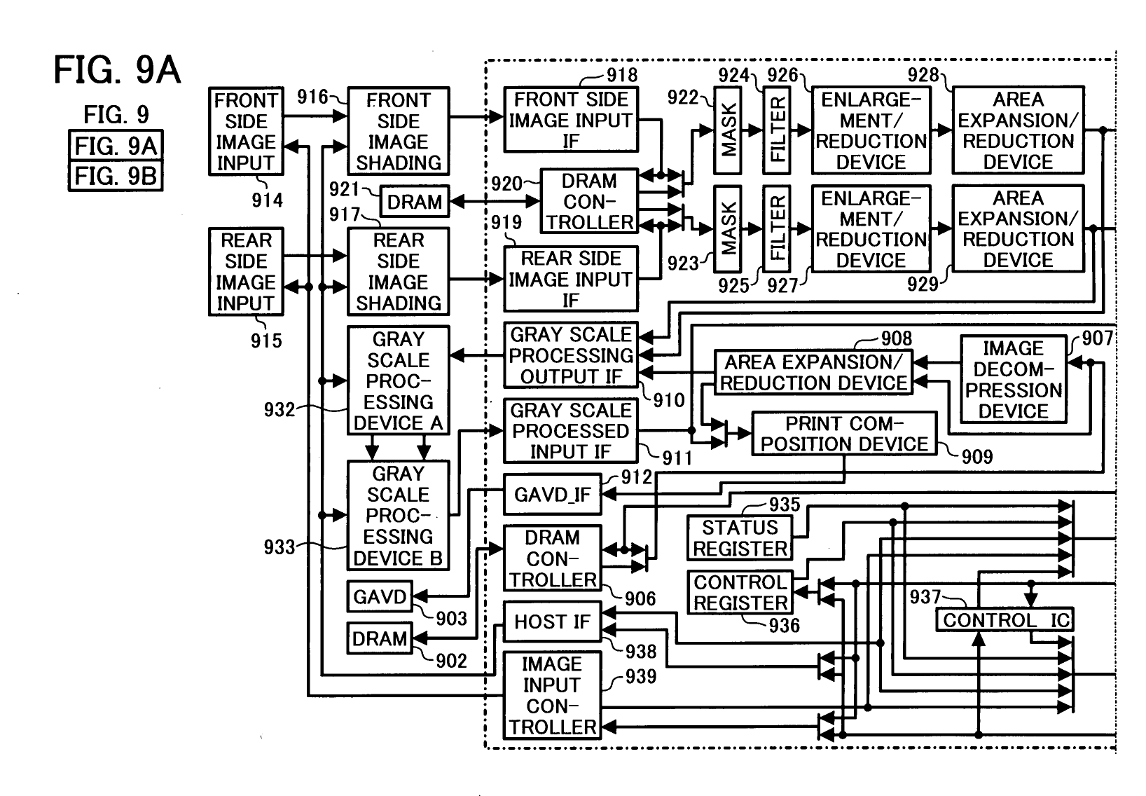

FIG. 8 is a schematic diagram of an illustrative ASIC 707 used in a controller of a multi-function apparatus consistent with the present invention. In FIG. 8, the ASIC 707 may read image data from the engine unit 760 via the PCI bus 770 and may store the image data into the local memory 708.

The ASIC 707 may include an image input DMAC 801 and an image input DMAC 802 used for inputting, and an image output DMAC 803 used for outputting. Different addresses of the PCI bus 770 may be allocated to the image input DMAC 801, the image input DMAC 802, and the image output DMAC 803, so that image data from a scanner 1 input 804, image data from a scanner 2 input 805, and image data to an plotter output 806 can be transferred in parallel, synchronously or asynchronously.

When image data from the scanner 1 input 804 corresponds to a front side surface of an original document and image data from the scanner 2 input 805 corresponds to a rear side surface of the original document, the IMH 641 (FIG. 6) may secure, for each image data, a memory area of Xw dots horizontally and Yw dots vertically, which may correspond to a data size of each image data, in the local memory 708, may set addresses of respective memory areas in the image input DMAC 801 and the image input DMAC 802, and may perform transferring of the image data from the scanner 1 input 804 and the image data from the scanner 2 input 805, for example, at the same time. In one embodiment consistent with the present invention, to store binary image data of an A4 size (210 mm×297 mm) read at a resolution of 600 DPI, Xw may be 960 dots and Yw may be 7016 lines. The image input DMAC 801 may transfer a scanner 1 input image 804b (may correspond to the image data from the scanner 1 input 804) to a scanner 1 address 804a, and a scanner 2 input image 805b (may correspond to the image data from the scanner 2 input 805) to a scanner 2 address 805a. The image output DMAC 803 may output image data stored in the local memory 708 to a plotter output 806 of the engine unit 760, for example, via the PCI bus 770.

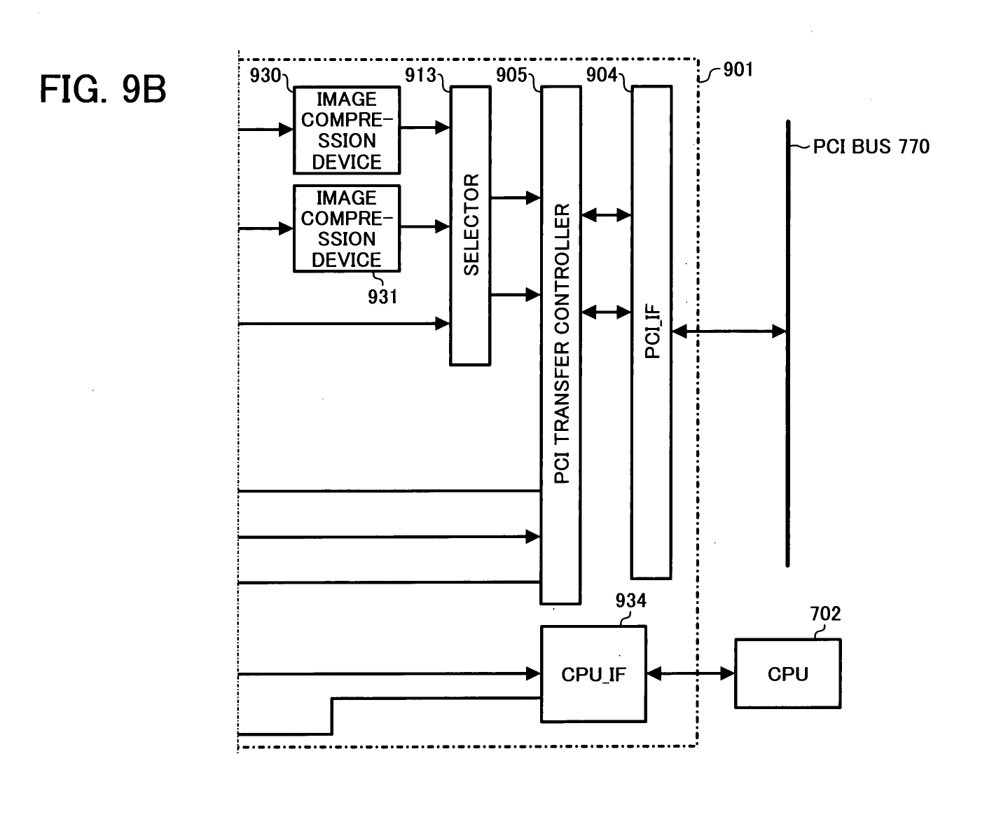

FIG. 9A and FIG. 9B show an illustrative embodiment of an engine unit 760 of a multi-function apparatus consistent with the present invention. An image data control I/F controller 901 may be controlled by the CPU 702 of the controller 701. The CPU 702 of the controller 701 may control the engine unit 760 via a CPU_IF 934 using, for example, a control register 936, a status register 935, and a control IC 937.

The image data control I/F controller 901 may control inputting of image data via a host IF 938 and an image input controller 939 by control of the control IC 937. The image data control I/F controller 901 may input image data via a PCI_IF 904. Front side image data and rear side image data may be transmitted from a front side image input 914 and a rear side image input 915 to a front side image shading 916 and a rear side image shading 917, where signal deterioration may be corrected. Then, the front side image data and the rear side image data may be inputted to a front side image input IF 918 and a rear side image input IF 919 of the image data control I/F controller 901.

Inputted front side image data and rear side image data may be written, via a DRAM controller 920, into a DRAM 921. When outputting the inputted front side image data and the rear side image data through a PCI transfer controller 905 as they are, the front side image data and the rear side image data may be transferred to a selector 913 via various image data processing function blocks, such as masks 922 and 923, filters 924 and 925, enlargement/reduction devices 926 and 927, area expansion/reduction devices 928 and 929, and image compression devices 930 and 931. Image data outputted from the selector 913 may be outputted, for example, to an external storage device.

The image data control IF controller 901 may include a DRAM 902 that may serve as a buffer memory for temporarily storing an input signal, and a GAVD (Gate Array for Video Data Control) 903 that may serve as an image output device to output image data to a printer for printing the image, a display device for displaying the image data, and a storage device for storing the image data. The image data control IF controller 901 may output an input signal to and input an output signal from an external storage device, for example, via the PCI bus 770.

The DRAM 902 may be a storage device for temporarily storing input image data, and may be used when adjusting a speed of writing data into the GAVD 903. In this embodiment, writing of image data into the DRAM 902 and reading out of image data from the DRAM 902 may be executed in parallel.

An operation of writing image data to the GAVD 903 may be divided into two steps, writing input image data into a buffer memory (i.e., the DRAM 902), and reading the image data stored in the buffer memory (the DRAM 902) and writing the image data to the GAVD 903. When a buffer memory (e.g., the DRAM 902) is not provided or the capacity of a buffer memory (e.g., the DRAM 902) is not large enough, input image data may be directly written to the GAVD 903.

Referring to FIG. 9A and FIG. 9B, image data stored in an external storage device and transferred to the engine unit 760 via the PCI bus 770 may be inputted to the image data control IF controller 901, and the image data inputted to the image data control IF 901 may be transferred to the DRAM 902 that may serve as a buffer memory via the DRAM controller 906 by the PCI transfer controller 905. The input image data may be sequentially written into the DRAM 902 to be stored.

Image data stored in the DRAM 902 may be transferred to a GAVD_IF 912 via various image data processing function blocks, such as an image decompression device 907, an area expansion/reduction device 908, a print composition device 909, a gray scale processing output IF 910, a gray scale processing device A 932, a gray scale processing device B 933, and a gray scale processed data input IF 911. The transferred image data may be displayed by the GAVD 903.

The PCI transfer controller 905 may output image data outputted from the selector 913 to a storage device and may input image data from the storage device. The PCI transfer controller 905 may set a data capacity and an image data transfer speed for each image data.

If image data written into the DRAM 902 that may serve as a buffer memory remains in the DRAM 902 even after the image data has been read out, there is a possibility that the image data remained in the DRAM 902 is seen or taken out. Therefore, image data stored in the DRAM 902 may be deleted when a desired process to the image data has been completed. For example, after image data in the DRAM 902 has been read out and written to the GAVD 903, the image data remaining in the DRAM 902 may be overwritten with meaningless numerical information, or the refreshing operation of the DRAM 902 may be stopped.

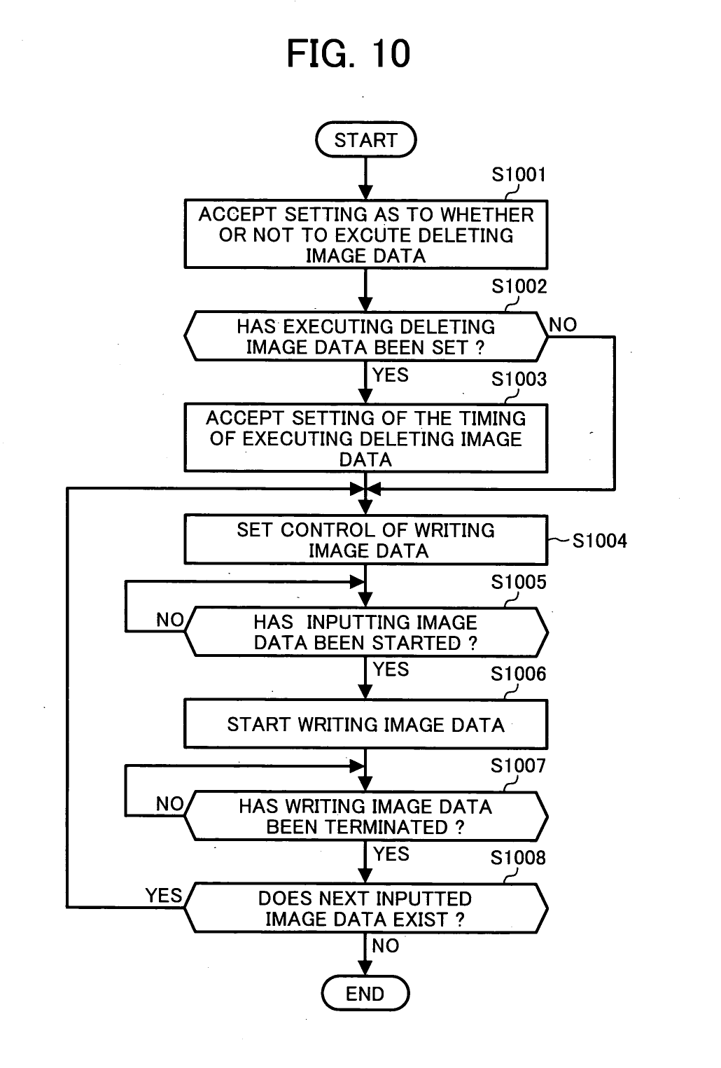

FIG. 10 is a flowchart illustrating a procedure when writing inputted image data stored in the DRAM 902 that may serve as the buffer memory to the GAVD 903 as the image output device to be outputted to a printer, an external storage device, etc. in the multi-function apparatus 601 and when writing inputted image data stored in the image memory 402 that may serve as the buffer memory to the writing unit 118 to be outputted onto a print sheet in the digital copier 100. The description is made using elements of the multi-function apparatus 601, with corresponding elements of the digital copier 100 added in parenthesis when necessary.

First, setting regarding whether or not to execute deleting of image data, inputted from the operation panel 720 (the operation unit 103), may be accepted (step S1001). When executing deleting of image data is set, image data in the DRAM 902 (the image memory 402), that has been read out from the DRAM 902 and written to the GAVD 903 (the writing unit 118) to be outputted to a printer, etc. (a print sheet), may be deleted after the image data has been read out from the DRAM 902 to be written to the GAVD 903.

Then, it may be determined if executing deleting of image data has been set (step S1002). When executing deleting of image data has not been set (No in step S1002), the procedure may proceed to step S1004. When executing deleting of image data has been set (Yes in step S1002), setting of the timing of executing deleting of image data, inputted from the operation panel 720, may be accepted (step S1003). Here, the timing of executing deleting of image data may refer to a time to delete image data stored in the DRAM 902 after the image data has been read from the DRAM 902 and written to the GAVD 903. The image data may be deleted, for example, when image data for one pixel, image data for one line, or image data for one page has been transferred from the DRAM 902 to the GAVD 903. In other words, the time of executing deleting of image data may be arbitrarily set. In one embodiment consistent with the present invention, the time may be set, for example, such that image data is deleted in a unit of one pixel each time image data for one pixel has been transferred from the DRAM 902 to the GAVD 903, or such that image data is deleted in a unit of one line each time image data for one line has been transferred from the DRAM 902 to the GAVD 903, or such that image data is deleted in a unit of one page each time image data for one page has been transferred from the DRAM 902 to the GAVD 903.

Next, control of writing image data may be set (step S1004). Here, writing image data may refer to an operation of reading out image data, inputted from a scanner, etc. and stored in the DRAM 902, from the DRAM 902 and writing the image data to the GAVD 903 for outputting the image data to a printer, etc. It may then be determined if inputting image data for writing the image data to the GAVD 903 has been started (step S1005). When inputting image data for writing the image data to the GAVD 903 has not been started (No in step S1005), the procedure returns to step S1005. When inputting image data for writing the image data to the GAVD 903 has been started (Yes in step S1005), writing image data to the GAVD 903 is started (step S1006). Then, it is determined if writing image data to the GAVD 903 has been terminated (step S1007). When writing image data to the GAVD 903 has not been terminated (No in step S1007), the procedure returns to step S1007. When writing image data to the GAVD 903 has been terminated (Yes in step S1007), it is determined if next image data inputted for writing the image data to the GAVD 903 exists (step S1008). When next image data inputted for writing the image data to the GAVD 903 exists (Yes in step S1008), the procedure returns to step S1004. When next image data inputted for writing the image data to the GAVD 903 does not exist (No in step S1008), the procedure ends.

Whether or not to execute deleting of image data in the DRAM 902 may be preset or set each time when inputting image data from a scanner, etc. for outputting the image data to a printer, etc.

Those skilled in the art will recognize that the steps described above may be performed concurrently or in a different order.

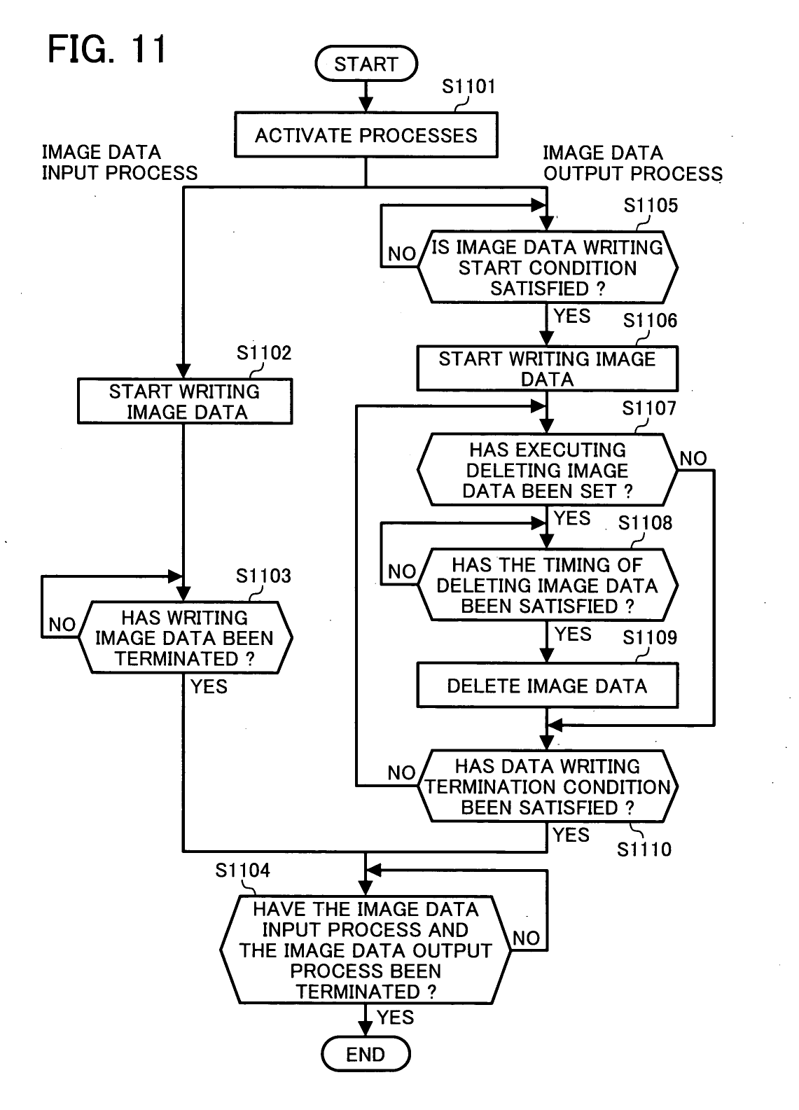

FIG. 11 is a flowchart illustrating a procedure of executing processes when writing inputted image data stored in the DRAM 902 to the GAVD 903 to be outputted to a printer, etc., in the multi-function apparatus 601 and when writing inputted image data stored in the image memory 402 to the writing unit 118 to be outputted onto a print sheet in the digital copier 100. The description is made using elements of the multi-function apparatus 601, with corresponding elements of the digital copier 100 added in parenthesis when necessary.

Two processes, an image data input process for inputting image data from the PCI bus 770 into the DRAM 902 and an image data output process for reading out image data stored in the DRAM 902 and writing the image data to the GAVD 903, may be activated in parallel (step S1101).

First, the image data input process starts writing image data into the DRAM 902 (step S1102). Then, it may be determined if writing image data into the DRAM 902 has been terminated (step S1103). When writing image data into the DRAM 902 has not been terminated (No in step S1003), the procedure returns to step S1103. When writing image data into the DRAM 902 has been terminated (Yes in step S1103), it is determined if the image data input process and the image data output process have been terminated (step S1104). When the image data input process and the image data out process have not been terminated (No in step S1104), the procedure returns to step S1104. When the image data input process and the image data output process have been terminated (Yes in step S1104), the procedure ends.

The image data output process first determines if an image data writing start condition is satisfied (step S1105). Here, one of the image data writing conditions may be that the image data input process has been started, that image data for a predetermined number of lines has been written into the DRAM 902 with the image data input process, etc. When the image data writing start condition provides the condition that the image data input has been started, reading image data from the DRAM 902 and writing the image data to the GAVD 903 is started at the same time when writing image data into the DRAM 902 has been started. When the image data writing start condition provides the condition that image data for a predetermined number of lines has been written into the DRAM 902 with the image data input process, after image data for the predetermined number of lines has been written into the DRAM 902 with the image data input process, reading out the image data for the predetermined number of lines stored in the DRAM 902 and writing the image data to the GAVD 903 is started. Which condition to adopt for the image data writing start condition may be determined in advance. When the image data writing start condition is not satisfied (No in step S1105), the procedure returns to step S1105. When the image data writing start condition is satisfied (Yes in step S1105), writing image data to the GAVD 903 is started (step S1106).

It is then determined if executing deleting image data in the DRAM 902 has been set (step S1107). When executing deleting image data in the DRAM 902 has not been set (No in step S1107), the procedure proceeds to step S1110. When executing deleting image data in the DRAM 902 has been set (Yes in step S1107), it is determined if the timing of deleting image data in the DRAM 902 has been satisfied (step S1108). When the timing of deleting image data in the DRAM 902 has not been satisfied (No in step S1108), the procedure returns to step S1108. When the timing of deleting image data in the DRAM 902 has been satisfied (Yes in step S1108), image data in the DRAM 902 (the image memory 402) is deleted under control of the CPU 702 (the memory controller 403) (step S1109).

Then, it is determined if a data writing termination condition has been satisfied (if a predetermined amount of data has been written to the GAVD 903 with the image data writing process) (step S1110). When the data writing termination condition has not been satisfied (No in step S1110), the procedure returns to step S1107. When the data writing termination condition has been satisfied (Yes in step S1110), it is determined if the image data input process and the image data output process have been terminated (step S1104). When the image data input process and the image data output process have not been terminated (No in step S1104), the procedure returns to step S1104. When the image data input process and the image data output process have been terminated (Yes in step S1104), the procedure ends.

Those skilled in the art will recognize that the steps described above may be performed concurrently or in a different order.

As described above, in the multi-function apparatus 601, image data inputted from a scanner, etc, and temporarily stored in the DRAM 902 to be written to the GAVD 903 for outputting the image data to a printer, etc. can be deleted after writing the image data stored in the DRAM 902 to the GAVD 903 under control of the controller 701. Thereby, a possibility that image data stored in the DRAM 902 is read by a third party after the image data in the DRAM 902 has been written to the GAVD 903 for outputting the image data to a printer, etc. may be avoided. Thus, leakage of image data inputted to the multi-function apparatus 601 and temporarily stored in the DRAM 902 as the buffer memory can be prevented.

Similarly, in the digital copier 100, image data inputted from the image reading unit 101 and temporarily stored in the image memory 402 of the storage unit 105 can be deleted after writing the image data stored in the image memory 402 to the writing unit 118 under control of the memory controller 403. Thereby, a possibility that image data stored in the image memory 402 of the storage unit 105 is read by a third party after the image data in the image memory 402 has been written to the writing unit 118 to be outputted on a print sheet may be avoided. Thus, leakage of image data inputted to the digital copier 100 and temporarily stored in the image memory 402 as the buffer memory can be prevented.

Further, as described above, the timing of deleting image data in the DRAM 902 (the image memory 402) can be arbitrarily set, so that the unit amount of image data to be deleted at one time when deleting image data in the DRAM 902 (the image memory 402) can be arbitrarily determined. For example, image data can be deleted in units of pixels, lines, pages, etc. Therefore, by selecting a finer unit for the unit amount of image data to be deleted at one time, for example, for image data of a higher secrecy class, the time that the image data is kept remained in the DRAM 902 (the image memory 402) after the image data has been written to the GAVD 903 (the writing unit 118), can be decreased. Thereby, a possibility that such image data of a higher secrecy class stored in the DRAM 902 (the image memory 402) is read by a third party can be minimized. Furthermore, by appropriately selecting the unit amount of image data to be deleted at one time according to secrecy classes of image data, the time required in deleting image data in the DRAM 902 (the image memory 402) can be adjusted. Thereby, the time required in outputting image data can be prevented from being increased unnecessarily.

Furthermore, because the timing of deleting image data in the DRAM 902 (the image memory 402) can be set to arbitrary timing, leakage of the image data can be prevented without decreasing the processing productivity of the multi-function apparatus 601 (the digital copier 100).

Further, deleting image data in the DRAM 902 (the image memory 402) is realized using software, without adding a specific hardware element, so that increase in the cost of the multi-function apparatus 601 (the digital copier 100) can be avoided, and changes in the specification of deleting of image data can be more flexibly dealt with than when the specific hardware element is added.

Further, in the multi-function apparatus 601, as described above, the image input DMAC 801, the image input DMAC 802 and the image output DMAC 803 are configured to transfer image data in parallel synchronously and asynchronously, so that the method of transferring image data can be appropriately changed according to the functions and constructions (e.g., the data transfer speed, the data reading speed, etc.) of inputting and outputting devices.

Numerous additional modifications and variations of the present invention are possible in light of the above-teachings. For example, while certain structure has been described in terms of hardware, any number of such structures may be embodied in a software or firmware implementation. It is therefore to be understood that within the scope of the claims, the present invention can be practiced otherwise than as specifically described herein.

The present application contains subject matter related to Japanese patent application no. JP 2003-400441, filed in the Japanese Patent Office on Nov. 28, 2003, the entire contents of which are incorporated herein by reference.

1. An image forming apparatus, comprising:
an image input device configured to receive image data;
a storage device configured to temporarily store the image data inputted by the image input device;
an image output device configured to output the image data read from the storage device; and
a deletion device configured to delete the image data stored in the storage device.

2. The image forming apparatus according to claim 1, further comprising:
a setting device configured to set whether or not to delete the image data stored in the storage device by the deletion device.

3. The image forming apparatus according to claim 1,
wherein the deletion device deletes the image data stored in the storage device in a unit of one or more pixels.

4. The image forming apparatus according to claim 1, further comprising:
a setting device configured to set a unit amount of image data to be deleted at one time when the image data stored in the storage device is deleted by the image deletion device.

5. The image forming apparatus according to claim 1,
wherein the image deletion device deletes the image data stored in the storage device when reading of the image data from the storage device has been completed.

6. The image forming apparatus according to claim 1,
wherein the image output device is configured to output the image data read from the storage device to at least one of a storage device storing the image data, a display device displaying the image data, and a print device printing the image data.

7. The image forming apparatus according to claim 1, further comprising:
an image data processing device configured to perform image data processing of the image data so as to provide processed image data,
wherein the image output device outputs the processed image data.

8. The image forming apparatus according to claim 7,
wherein the image deletion device deletes the image data stored in the storage device when the image data processing of the image data by the image data processing device has been completed or when outputting of the processed image data has been completed.

9. The image forming apparatus according to claim 7,
wherein the image output device is configured to output the processed image data to at least one of a storage unit storing the processed image data, a display device displaying the processed image data, and a print device printing the processed image data.

10. An image forming apparatus, comprising:
an image input device configured to receive image data;
a storage device configured to temporarily store the image data inputted by the image input device;
an image output device configured to output the image data read from the storage device; and
means for deleting the image data stored in the means for temporarily storing.

11. A method of inputting image data with an image input device and outputting the image data with an image output device in an image forming apparatus, the method comprising:
inputting image data with the image input device;
temporarily storing the image data in a storage device;
outputting the image data read from the storage device with the image output device; and
deleting the image data temporarily stored in the storage device.

12. The method according to claim 11,
wherein the deleting of the image data includes deleting the image data temporarily stored in the storage device in a unit of one or more pixels.

13. The method according to claim 11, further comprising:
setting whether or not to delete image data temporarily stored in the storage device.

14. The method according to claim 11, further comprising:
setting a unit amount of image data to be deleted at one time when the image data temporarily stored in the storage device is deleted in the deletion step.

15. The method according to claim 11,
wherein the deleting of the image data includes deleting the image data stored in the storage device when reading of the image data from the storage device has been completed.

16. The method according to claim 11,
wherein the outputting of the image data includes outputting the image data read from the storage device to at least one of a storage unit storing the image data, a display device displaying the image data, and a print device printing the image data.

17. The method according to claim 11, further comprising:
performing image data processing of the image data so as to provide processed image data; and
outputting the processed image data after performing the image data processing of the image data.

18. The method according to claim 17,
wherein the deletion of the image data includes deleting the image data temporarily stored in the storage device when the image data processing of the image data in the image data processing performing step has been completed or when outputting of the processed image data has been completed.

19. The method according to claim 17,
wherein the outputting of the processed image data includes outputting the processed image data to at least one of a storage unit storing the processed image data, a display device displaying the processed image data, and a print device printing the processed image data.
